(19) United States
(12) Patent Application Publication
(10) Pub. No.: US 2009/0160765 A1
(43) Pub. Date: Jun. 25, 2009

(54) INPUTTING UNIT, INPUTTING METHOD, AND INFORMATION PROCESSING EQUIPMENT

(75) Inventor: Tomohiro HANYU, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/240,620

(22) Filed: Sep. 29, 2008

(30) Foreign Application Priority Data
Dec. 21, 2007 (JP) 2007-330159

(51) Int. Cl. G09G 5/00

(52) U.S. Cl. 345/156

(57) ABSTRACT

According to one embodiment, an inputting unit for inputting a first control instruction to change a display status of a screen, includes: an acceleration acquiring section configured to acquire an acceleration applied to the inputting unit; an acceleration determining section configured to output a first signal when the acceleration exceeds a certain numerical value; a user's instruction acquiring section configured to allow a user to input a second signal at the inputting unit at any point of time; and a focus change determining section configured to output a second control instruction to move a focus in the screen when the first signal and the second signal are input.

### CROSS-REFERENCE TO RELATED APPLICATIONS

This application is based upon and claims the benefit of priority from Japanese Patent Application No. 2007-330159, filed on Dec. 21, 2007, the entire contents of which are incorporated herein by reference.

### BACKGROUND

1. Field

One embodiment of the present invention relates to an inputting unit for giving instructions on screen operation to an information processing equipment and, more particularly, an inputting unit, an inputting method, and an information processing equipment using the same, which enables a user to give instructions by shaking the information processing equipment while holding it in hand.

2. Description of the Related Art

As the inputting unit of the information equipment typified by Personal Computer (PC), an interface such as keyboard, mouse, or the like is utilized. In giving instructions on the screen operation, or the like to the information equipment, the user moves a cursor up/down and right/left by operating a keyboard or using a mouse.

For example, in case the information equipment is used as the mobile equipment that is portable, it is desired that the user can operate such equipment while holding it in user's hand. However, in order to operate the keyboard or the mouse in the related art, the information equipment must be put on a flat stable place, or the like to keep user's hands free. Therefore, it is often difficult for the user to operate the information equipment in a hand-held condition.

For this reason, a method of detecting a motion of a main body of the information equipment by an acceleration sensor and instructing the information equipment to take a predetermined operation in response to the motion (see JP-A-2000-47813, for instance).

When the information equipment is designed such that the user can instruct this equipment to take a predetermined operation by shaking the main body while holding it, the user can instruct the information equipment to perform a desired operation while holding the main body in hand. However, the user tries to use the information equipment in the hand-held condition while walking, for example, such user shakes unconsciously the main body of the information equipment. As a result, a malfunction of equipment may be caused.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing an example of an information processing equipment according to an embodiment of the present invention;

FIG. 2 is a view showing an example of a block configurative view of the information processing equipment according to the embodiment;

FIG. 3 is a view showing an example of a display screen of the information processing equipment according to the embodiment;

FIG. 4 is a view showing a relationship between user interface components configuring the screen;

FIG. 5 is a view showing an example of a functional block configurative view according to the embodiment; and

FIG. 6 is a view showing an example of an input focus changing flow according to the embodiment.

### DETAILED DESCRIPTION

Various embodiments according to the invention will be described hereinafter with reference to the accompanying drawings. In general, according to one embodiment of the invention, an inputting unit for inputting a first control instruction to change a display status of a screen, includes: an acceleration acquiring section configured to acquire an acceleration applied to the inputting unit; an acceleration determining section configured to output a first signal when the acceleration exceeds a certain numerical value; a user's instruction acquiring section configured to allow a user to input a second signal at the inputting unit at any point of time; and a focus change determining section configured to output a second control instruction to move a focus in the screen when the first signal and the second signal are input.

### Present Embodiment

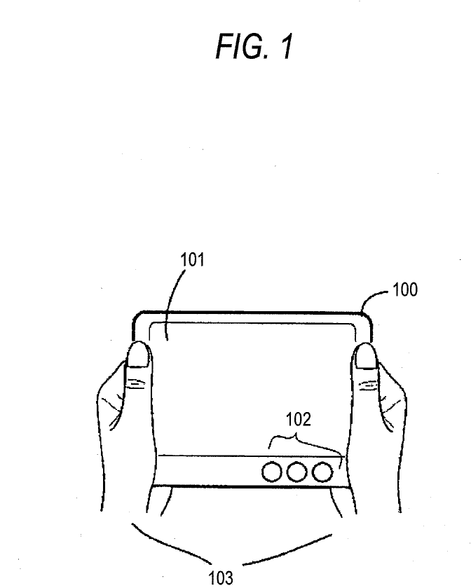

FIG. 1 is a view showing an example of an information processing equipment according to an embodiment of the present invention. In FIG. 1, a PC 100, a display 101, buttons 102, and an operator 103 are illustrated.

The PC 100 is a portable compact personal computer like a Personal Digital Assistant (PDA), for example. In the present embodiment, the PC equipped with no keyboard is illustrated. But the PC 100 is not limited to this model.

The display 101 is a display device that is incorporated into the PC 100. For example, a Liquid Crystal Display (LCD) may be employed, and the PC 100 displays information for a user.

The buttons 102 are an inputting unit that is incorporated into the PC 100. The user of the PC 100 can give certain instructions by pressing the buttons 102. In the present embodiment, the buttons 102 are positioned below a screen of the display 101. Besides, such a case may be considered that, when the buttons 102 are arranged in a position where the user can press them easily while holding the PC 100 in hand, preferably a position on which user's thumb touches when the user grasps naturally the PC 100 in both hands, such position makes handling easier.

Such an example is illustrated that the operator 103 grasps a main body of the PC 100 in both hands to utilize the display 101 as desired. Of course, the operator 103 may grasp the main body in one hand, as needed. Such grasping way may make it easier to shake the main body of the PC 100.

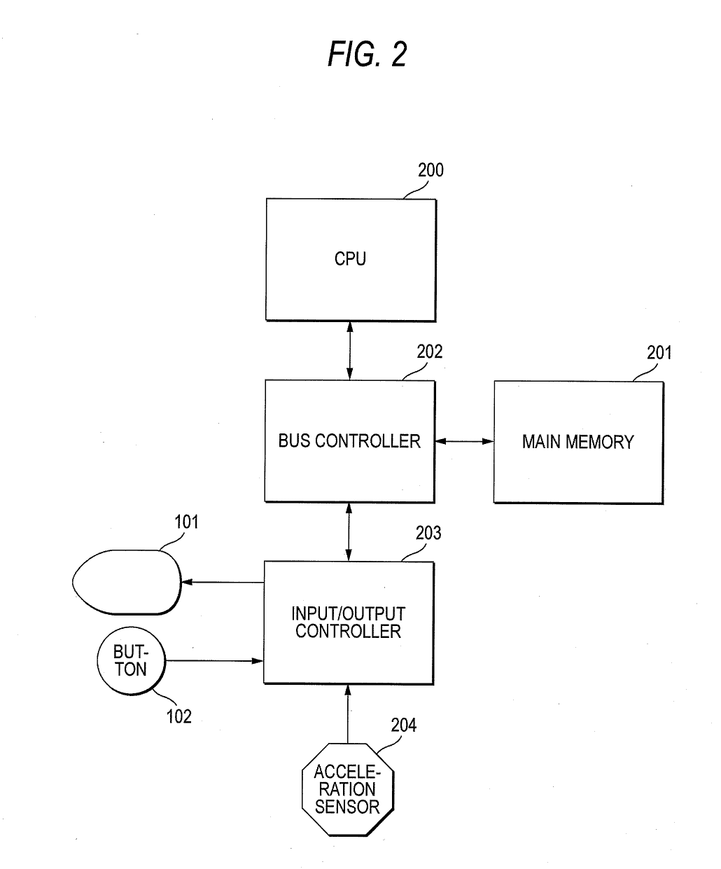

FIG. 2 is a view showing an example of a block configurative view of the information processing equipment according to the present embodiment. In FIG. 2, a CPU 200, a main memory 201, a bus controller 202, an input/output controller 203, and an acceleration sensor 204 are illustrated.

The CPU 200 is a central processing unit, and controls the overall PC100. Also, the CPU 200 has a function of running a program and performing a certain process in response to the program.

The main memory 201 is configured of a semiconductor memory. This main memory 201 is utilized as a storage area of the program and data when the CPU 200 runs the program.

The bus controller 202 has a function of controlling a bus that transmits information between respective constituent elements of the information equipment 100. The instruction from the CPU 200 is transmitted via the bus to read/write the data in the main memory 201 or is given to other equipment.

The input/output controller 203 has a function of providing interfaces between the CPU 200 and various input/output devices such as the display 101, the buttons 102, and the like.

The acceleration sensor 204 is a sensor that is arranged in the main body of the PC100 and is capable of measuring an acceleration when the main body is shaken. Several methods of measuring the acceleration have been proposed. The measuring method is not particularly limited herein, and any method can be applied. Preferably the compact and low-power type sensor that has a quick response speed in detection and is capable of measuring the accelerations applied in all directions respectively.

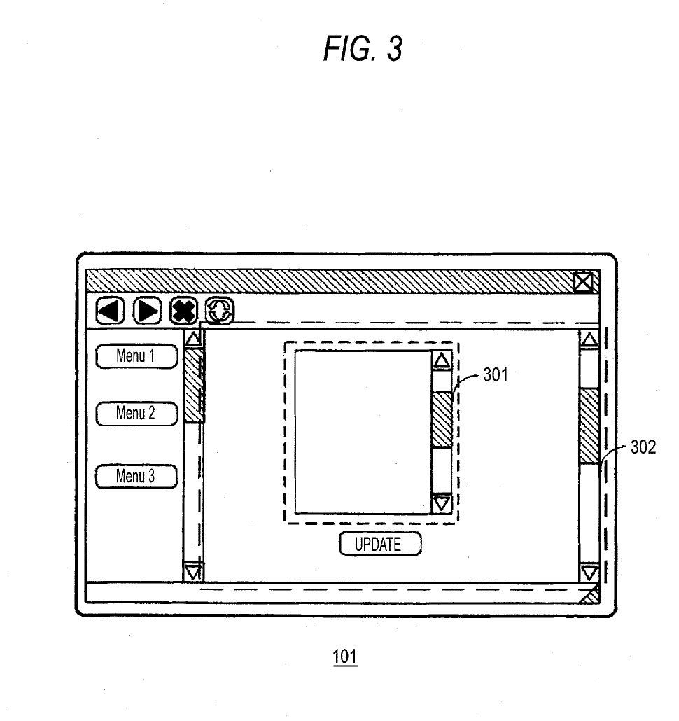

FIG. 3 is a view showing an example of a display screen displayed on the display 101 of the information processing equipment according to the present embodiment. In FIG. 3, user interface components 301, 302 are shown.

As shown in FIG. 3, the user interface components 301, 302 are components in which a text input area and buttons used to give any instruction are arranged, for example. In a broad sense, the user interface component denotes the overall components configuring the screen that can receive the instruction from the operator.

It is common that one screen includes a plurality of user interface components. Which does not matter when a desired user interface component on the screen can be operated directly by using the pointing device like the mouse. But the user interface component is operated by moving the input focus when no pointing device is provided like the PC 100. The “input focus” places the focus on one of a plurality of user interface components configuring the display screen. The instruction is input only into the user interface component that is in its focused condition. The user can designate the input designation exclusively by moving the focus onto the user interface component to which the instruction is to be input.

For example, the input focus is put on the user interface component 301, the user can input the characters, or the like only into the user interface component 301. When the input focus is moved to the user interface component 302, the user interface component 301 loses the input focus, and thus the user can not input the text into the user interface component 301. Then, once the user interface component 302 acquires the input focus, the user can press the button that is labeled “update”.

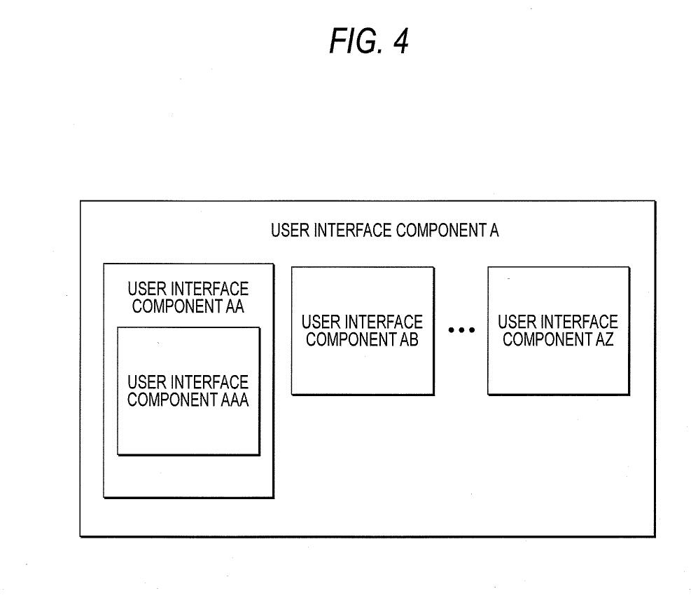

FIG. 4 is a view showing a relationship between user interface components configuring the screen. In the present embodiment, the user interface components configuring the display screen have the attribute respectively, and are managed in compliance with the object oriented concept.

In moving the input focus, the user must decide to which user interface components the input focus should be moved to. As described above, the user interface components have the attribute respectively. In deciding the destination of movement, the user can utilize distinguishable ID or display coordinate, component attribute such as the character input frame, the button, the scroll bar, or the like, parent-child attribute whose hierarchies are managed, and the like.

For example, the user can choose the component that has the next larger ID value than the component that is currently in the input focus or the button belonging to the same form. Alternately, such a configuration may be employed that the input focus is moved only onto the user interface components having the button attribute.

In addition, when the acceleration sensor 204 can detect the acceleration in the up/down and right/left directions of the display screen respectively, the user can designate directly the components that are located in the up/down and right/left positions from the components that currently has the input focus, from the attribute display coordinate as the destination of movement of the input focus.

Also, when the user decides which user interface components the input focus should be moved to, by using a combination of these attributes, the usability according to operation can be improved.

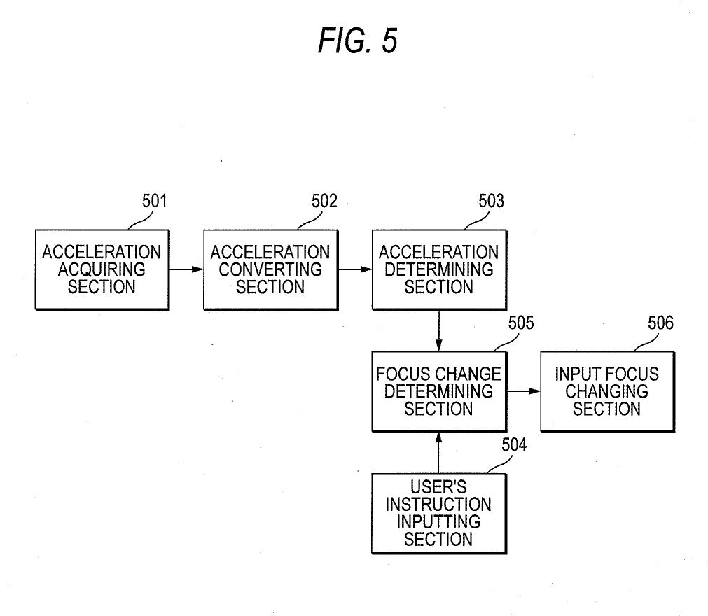

FIG. 5 is a view showing an example of a functional block configurative view according to the present embodiment. In FIG. 5, an acceleration acquiring section 501, an acceleration converting section 502, an acceleration determining section 503, a user's instruction inputting section 504, a focus change determining section 505, and an input focus changing section 506 are illustrated.

The acceleration acquiring section 501 has a function of capturing electrically acceleration information acquired by the acceleration sensor 204.

The acceleration converting section 502 has a function of converting the electrical acceleration information acquired by the acceleration acquiring section 501 into digitized information. Since the acceleration information acquired by the acceleration sensor 204 is normally an analog value, the acceleration information is converted to the digitized information for the CPU 200 to process easier.

The acceleration determining section 503 has a function of determining whether or not the PC 100 is shaken intentionally by the operator. The acceleration information digitized by the acceleration converting section 502 contains the information acquired by the operator's unconscious shaking of the PC 100. Since such operation indicated by such information was not intended originally, the information should not be reflected in the operation of the PC 100. For this purpose, when a numerical value indicating that the acceleration in excess of a certain value is applied, i.e., the operator shook intentionally this equipment is detected, the PC 100 of the present embodiment determines that the operator operates this equipment.

In the embodiment, the user's instruction inputting section 504 denotes the button 103 concretely. While holding the main body of the PC 100 in hand and shaking it, the operator presses the buttons 103 to move the input focus. The buttons 103 are used together for the purpose of instructing explicitly that the operator is operating the PC 100. As described above, the acceleration determining section 503 determines whether or not the instruction on the operation was given, based on a threshold value provided to the detected acceleration. Nevertheless, such a situation is unavoidable that, when the operator moves unexpectedly the PC 100, it is determined sometimes that the instruction on the operation was given. Therefore, the user's instruction inputting section 504 is provided to indicate whether or not the operator intends to operate the PC 100.

The focus change determining section 505 determines whether or not the change of the input focus was instructed, based on both results of the acceleration determining section 503 and the user's instruction inputting section 504. Here, the focus change determining section 505 has a function of determining that the input focus should be changed when the detected accelerator is larger than the threshold value and the operator is issuing the instruction on the operation.

The input focus changing section 506 has a function of moving the input focus of the user interface component being displayed on the screen to another component, based on the determination result of the focus change determining section 505.

According to this configuration, a malfunction can be reduced, and also there is no necessity that an amount of shake required for the operation should be set excessively high. Therefore, the user can give the instructions on the operation by shaking the main body of the information equipment without fail irrespective of the using situation.

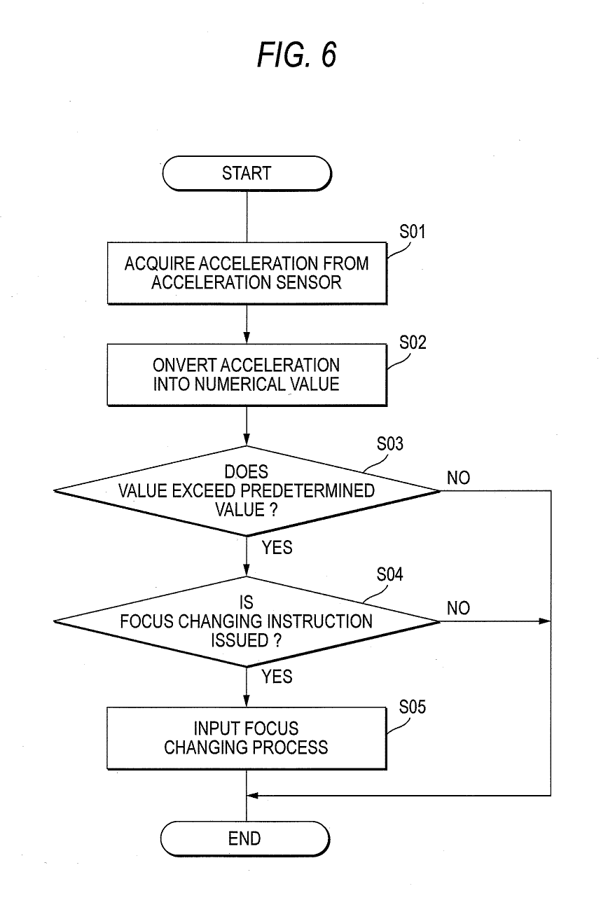

FIG. 6 is a view showing an example of an input focus changing flow according to the present embodiment.

First, the acceleration applied to the main body of the PC 100 is acquired from the acceleration sensor 204 (step S01).

Then, convert the acceleration information is digitized via the input/output controller 203 (step S02).

Then, the CPU 200 determines whether or not the acceleration value acquired from the input/output controller 203 exceeded a threshold value (step S03). If the acceleration value does not exceed the threshold value (No), the CPU 200 determines that the operation is not instructed by the operator. Then, the input focus changing process is ended.

In step S03, if the acceleration value exceeds the threshold value (Yes), the CPU 200 determines whether or not the buttons 103 are pressed at the same time when the acceleration is detected (step S04). In step S04, if the buttons 103 are not pressed (No), the CPU 200 determines that the operator does not intend to operate. Then, this changing process is ended.

In step S04, if the buttons 103 are pressed (Yes), the CPU 200 causes the input focus changing section 506 to change the input focus to another user interface component (step S05).

According to this configuration, the user can give the instructions on the operation by shaking the main body of the information equipment without fail irrespective of the using situation.

### Variation of the Embodiment

The input focus changing section 506 may determine such that the change destination of the input focus should be changed sequentially following to the previously determined sequence. According to this configuration, movement of the input focus can be controlled as previously intended to improve the usability, irrespective of a screen configuration.

Here, the present invention is not limited to the embodiment as it is, and the present invention may be embodied by varying the constituent elements within a scope not departing from a gist thereof in the implementing stage. Also, various inventions can be created by using an appropriate combination of a plurality of constituent elements disclosed in the embodiment. For example, several constituent elements may be deleted from all constituent elements disclosed in the embodiment. In addition, the constituent elements may be combined appropriately throughout different embodiments.

What is claimed is:

1. An inputting unit for inputting a first command to change a display status of a screen, comprising:
an acceleration detecting module configured to detect an acceleration of the inputting unit;
an acceleration determining module configured to output a first signal when the acceleration exceeds a predetermined numerical value;
a user command receiving module configured to allow a user to input a second signal at the inputting unit; and
a focus change determining module configured to output a second command to move a focus in the screen when the first signal and the second signal are input.

2. The inputting unit of claim 1, wherein the display of the screen comprises a first and a second user interface components, and the second command comprises an instruction to move the focus from the first user interface component to the second user interface component.

3. The inputting unit of claim 1, wherein
the acceleration detection module is configured to detect multi-dimensional acceleration,
the acceleration determining module is configured to output the first signal comprising information to identify a direction of the acceleration, and
the focus change determining module is configured to output a signal to move the focus in the direction.

4. An inputting method of inputting a first command to change a display status of a screen, into an information processing equipment, comprising:
detecting an acceleration by an acceleration sensor incorporated in the information processing equipment;
outputting a first signal when the acceleration exceeds a certain numerical value; and
outputting a second command to move a focus in the screen when the first signal and a second signal that a user inputs are detected simultaneously.

5. The inputting method of claim 4, wherein the display of the screen comprises a first and a second user interface components, and the second command comprises an instruction to move the focus from the first user interface component to the second user interface component based on a predetermined rule.

6. The inputting method of claim 5, wherein the predetermined rule comprises a rule to determine a user interface component having a predetermined attribute as the second user interface component.

7. An information processing equipment operable by a user while holding the equipment in hand, comprising:
a display configured to display an image on a screen;
an acceleration detecting module configured to detect an acceleration of the information processing equipment;
an acceleration determining module configured to output a first signal when the acceleration exceeds a predetermined numerical value;
a user command receiving module configured to allow a user to input a second signal; and
a focus change determining module configured to output a second command to move a focus in the screen when the first signal and the second signal are input.

8. The information processing equipment of claim 7, wherein the user command receiving module comprises button switches mounted on a surface of the information processing equipment.
